(19) United States
(12) Patent Application Publication
(10) Pub. No.: US 2026/0023792 A1
(43) Pub. Date: Jan. 22, 2026

(54) RETRIEVAL-AUGMENTED GENERATION FOR DOMAIN-SPECIFIC TECHNICAL DOCUMENTS

(71) Applicant: Intel Corporation, Santa Clara, CA (US)

(72) Inventors: Peixi Xiong, Hillsboro, OR (US); Chaunte Lacewell, Hillsboro, OR (US); Nilesh Jain, Portland, OR (US); Sameh Gobriel, Dublin, CA (US)

(73) Assignee: Intel Corporation, Santa Clara, CA (US)

(21) Appl. No.: 19/340,352

(22) Filed: Sep. 25, 2025

(51) Int. Cl. G06F 16/93; G06F 16/22

(52) U.S. Cl. CPC G06F 16/93; G06F 16/2282

(57) ABSTRACT

Effective Retrieval-Augmented Generation (RAG) pipelines face significant challenges when processing domain-specific technical documents that have diverse content types like text, figures, equations, and tables. To address this challenge, a context-oriented RAG system can be implemented for various domain-specific applications. The RAG system can include a lightweight, two-stage architecture to facilitate contextual understanding: a content analysis and enrichment pipeline for structured metadata extraction and a query processing pipeline for context-aware retrieval. In some cases, tabular data is processed using a dual-stream approach: semantically via text and visually via screenshots. The embedding vectors and the metadata can be stored in a visual data management system. The RAG system, utilizing the visual data management system, can answer questions and precisely retrieve technical information in a way that can preserve structural relationships and semantic connections across different modalities.

### BACKGROUND

Retrieval-Augmented Generation (RAG) is a framework in machine learning (ML) that combines information retrieval techniques with generative models to improve the accuracy and relevance of automated responses. In a RAG system, a user's query is used to search a large corpus of documents or data sources, retrieving the most relevant pieces of information. These retrieved documents are then provided as additional context to a large language model (LLM), which generates a response that is grounded in the retrieved content. This approach allows RAG systems to leverage both the broad knowledge encoded in generative models and the specificity of external, up-to-date information, making them especially effective for tasks that require factual accuracy, domain expertise, or context-sensitive answers. RAG has become a useful technique for applications such as question answering, technical support, and enterprise search, where combining retrieval and generation leads to more reliable and context-aware outputs.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a technical document collection, according to some embodiments of the disclosure.

FIG. 2 illustrates a content analysis and enrichment pipeline and a query processing pipeline, according to some embodiments of the disclosure.

FIG. 3 illustrates a content analysis and enrichment pipeline, according to some embodiments of the disclosure.

FIG. 4 illustrates a document parser, according to some embodiments of the disclosure.

FIG. 5 illustrates a media handler, according to some embodiments of the disclosure.

FIG. 6 illustrates a visual summarizer, according to some embodiments of the disclosure.

FIG. 7 illustrates exemplary metadata for different types of content chunks, according to some embodiments of the disclosure.

FIG. 8 illustrates a query processing pipeline, according to some embodiments of the disclosure.

FIG. 9 depicts a flow diagram illustrating a method for processing a document collection, according to some embodiments of the disclosure.

FIG. 10 depicts a flow diagram illustrating a method for generating a response to a query, according to some embodiments of the disclosure.

FIG. 11 depicts a flow diagram illustrating a method for processing a document collection, according to some embodiments of the disclosure.

FIG. 12 is a block diagram of an exemplary computing device, according to some embodiments of the disclosure.

### DETAILED DESCRIPTION

### Overview

RAG is used to enhance LLMs by integrating external knowledge bases. RAG frameworks combine retrieval systems with neural generation, offering a solution for knowledge-intensive tasks. These models retrieve contextually relevant data from external sources, which is then fused with LLM responses to improve accuracy and reduce hallucinations.

Effective RAG pipelines face significant challenges when processing domain-specific technical documents that have diverse content types like text, figures or images, mathematical equations, and tables. A technical document or structure having different content types such as text, figures or images, mathematical equations, and tables can be referred to as a “multimodal document or structure”. The growing complexity of technical, domain-specific documentation, which increasingly incorporates a diverse array of content types, including text, figures, equations, tables, and visualizations, presents significant hurdles for effective information retrieval and comprehension. Although these multimodal elements enhance clarity, they also introduce intricacies in maintaining structural relationships and achieving comprehensive contextual understanding across modalities. Context in technical documentation is valuable for accurate interpretation, particularly in domain-specific applications where context determines meaning.

LLMs trained on general information lack the specialized knowledge and nuances of technical, domain-specific data, and also demand substantial computational resources, making them less accessible for widespread adoption. For example, general purpose LLMs, while powerful, are trained on broad, non-specialized corpora and lack fine-grained domain knowledge and structural awareness to interpret complex technical documents effectively. The models demand substantial computational resources, limiting accessibility and scalability.

LLMs, which are used in RAG pipelines, often fail to capture the intricate structural relationships in technical documentation, highlighting the challenge for RAG systems to extract high-quality context for accurate interpretation. For example, these LLMs can fail to preserve the hierarchical and multimodal structure of technical documents, resulting in poor contextual comprehension and suboptimal retrieval accuracy.

The challenges in retrieving and understanding complex, domain-specific technical documents, which often include multimodal content such as figures, tables, and equations, can include but are not limited to: processing diverse content types beyond plain text, preserving structural and contextual relationships across modalities, ensuring accurate interpretation through deep contextual understanding, and overcoming the limitations of general LLMs and RAG systems, which struggled with technical nuance and structure.

To address one or more of these challenges, a context-oriented RAG system can be implemented for various domain-specific applications, specifically designed for answering queries based on complex, multimodal, domain-specific technical documentation. The RAG system can include a lightweight, two-stage architecture to facilitate contextual understanding: a content analysis and enrichment pipeline for structured metadata extraction and a query processing pipeline for context-aware retrieval. The two-stage architecture can effectively preserve structural and semantic relationships across text, figures, tables, and equations, and can enable more accurate and contextually grounded information retrieval and understanding than rag systems or general purpose LLM based techniques. Moreover, the two-stage pipeline can preserve hierarchical and multimodal context.

The content analysis and enrichment pipeline can produce embedding vectors and corresponding metadata that encapsulates structural and contextual information about content chunks (sometimes referred to simply as chunks) of a technical document collection. The pipeline can extract one or more content chunks from a document in the technical document collection. Documents in the technical document collection can have multimodal content. The one or more content chunks can include at least one of: a textual content chunk, an image content chunk, and a table content chunk. The pipeline can produce one or more embedding vectors and corresponding metadata for a given content chunk. In some embodiments, a content chunk size is 500 tokens.

In some embodiments, the content analysis and enrichment pipeline can perform hierarchical chunking to extract content chunks from the documents while preserving hierarchical relationships between content chunks in the metadata about the content chunks. When extracting the content chunks, the pipeline can assign a chunk identifier (ID) and a parent chunk ID (e.g., a source ID) to a given content chunk to preserve structural relationships between chunks. The IDs can be used as traceable hierarchical relational information.

In some embodiments, the content analysis and enrichment pipeline can implement an overlapping window technique when chunking. Ensuring that the content chunks overlap each other by an overlap amount, the pipeline can maintain semantic continuity between content chunks. In some cases, the overlap amount is 50 tokens. In some cases, the pipeline can extract and align multimodal elements, e.g., figures and tables, to their contextual anchors, such as captions and section header. Generating metadata based on content chunks that preserve their contextual anchors would ensure that contextual information is not lost but captured in the metadata.

In some cases, tabular data is processed using a dual-stream approach: semantically via text and visually via screenshots. The content analysis and enrichment pipeline can generate metadata for the table content chunk by processing text of the table content chunk and generates further metadata for the table content chunk by processing a screenshot of the table content chunk. The semantic processing stream can parse structured textual content such as table cells and figure descriptions. The text of the table can include a semantic representation, which can encompass machine-readable text of one or more of: table cell content, header row content, header column content, and table title content. The visual processing stream retains layout fidelity via screenshots and associates them with semantic metadata, such as titles, captions, keys, legends, and cross-references. The screenshot of the table can include a visual representation, which can encompass one or more of: table layout, table cell content, header row content, header column content, and table title content. The dual-stream approach can simultaneously preserve semantic meaning and visual layout, which is beneficial for understanding spatial relationships in tables and diagrams in technical domains. The dual-stream approach can also be applied to extract metadata other types of media content chunks, such as content chunks having pictures, graphics, graphs, charts, or diagrams. The dual-stream approach can process both semantic and visual representations while preserving layout, captions, and cross-modal links.

In some embodiments, the content analysis and enrichment pipeline includes: (1) a document parser that preserves hierarchical relationships, (2) a media handler that maintains structural integrity through dual-stream processing, and (3) a visual summarizer that generates context-rich semantic descriptions.

The content analysis and enrichment pipeline can generate an embedding vector for a given content chunk, such as the table content chunk. For the table content chunk, the content analysis and enrichment pipeline can store the embedding vector, the metadata, and the further metadata in a visual data management system (VDMS). For various content chunks extracted by the content analysis and enrichment pipeline, the embedding vectors and the metadata produced by the content analysis and enrichment pipeline can be stored in the VDMS.

The query processing pipeline can utilize the structure-aware representation in the VDMS to perform precise semantic retrieval and generate grounded responses to queries. Specifically, the VDMS can store the multimodal content of the technical document collection and index the content using the embedding vectors and metadata as a multimodal vector store. The VDMS can include a graph store to store metadata associated with one or more content chunks, and a vector store to store embedding vectors associated with the one or more content chunks. Phrased differently, the VDMS stores the content chunks and indexes the content chunks using the metadata and embedding vectors.

By storing embedding vectors for content chunks of different modalities, the VDMS can support multimodal content indexing. Additionally, the graph store of the VDMS allows for indexing of hierarchical chunks and retrieval of documents in a way that is grounded in how the content chunks are structurally related to each other. When integrated in a RAG system, the VDMS can retrieve documents in a way that would enable an LLM to produce answers or responses with structured grounding, offering a schema-driven, multimodal storage and retrieval approach that is context-aware.

The query processing pipeline leverages the enriched structural context stored in the VDMS to enable precise retrieval and contextually grounded response generation. The VDMS can allow efficient semantic retrieval by generating a dense vector and a filter based on the query, and utilizing the dense vector and the filter to perform semantic retrieval of documents in a way that would leverage the hierarchical structural information and contextual information encapsulated in the metadata store. The RAG system, utilizing the VDMS, can precisely retrieve technical information in a way that can preserve structural relationships and semantic connections across different modalities and answer questions utilizing the retrieved technical information while paying close attention to the structural and contextual information.

The architecture solves the problem of processing complex technical documentation by going beyond other RAG techniques. The sophisticated two-pipeline architecture that actively preserves and leverages the document's internal structure and multimodal content during analysis, enrichment, retrieval, and generation. This detailed, structure-aware processing allows the context-oriented RAG system to build a comprehensive contextual understanding that is fed to the LLM via tailored prompts and structured data from VDMS, resulting in more precise and accurate answers on challenging technical queries, even while using more efficient models.

A context-oriented RAG system implements a structure-aware approach to RAG that captures and leverages the intricate relationships between technical concepts, enabling better context and more precise responses. The RAG system offers a comprehensive framework for preserving and utilizing rich contextual relationships, including hierarchical relationships, structural integrity, and semantic connections, which can provide better context for accurate retrieval and generation of technical information. In addition, the RAG system enhances contextual understanding in technical documents by preserving structural relationships and semantic connections across different content types, leading to more accurate interpretation and retrieval of information. This can be particularly valuable in scenarios involving complex technical documentation, where the RAG system can allow users to quickly find and understand complicated information.

Because the VDMS can effectively and efficiently retrieve relevant documents that are grounded in structural and contextual information, a lightweight LLM can be used in the query pipeline (as opposed to the resource-intensive generic LLMs) to produce accurate responses to queries. Advantageously, the context-oriented RAG system is lightweight and efficient, and can achieve superior performance with reduced computational requirements, making it more accessible for widespread adoption. Therefore, the RAG system can provide more precise retrieval of technical information from complex domain-specific documents, while using smaller LLMs and less computational resources than other techniques. Additionally, the context-oriented RAG system can achieve high accuracy and technical document understanding with greater efficiency and reduced costs.

A context-oriented RAG system has broad applicability and can offer advanced RAG capabilities for domain-specific use, making it more accessible across varying levels of technical complexity. The system can be used to streamline the processing of technical document collections with diverse content and improve productivity and decision-making at different organizations.

### Content Analysis and Enrichment Pipeline

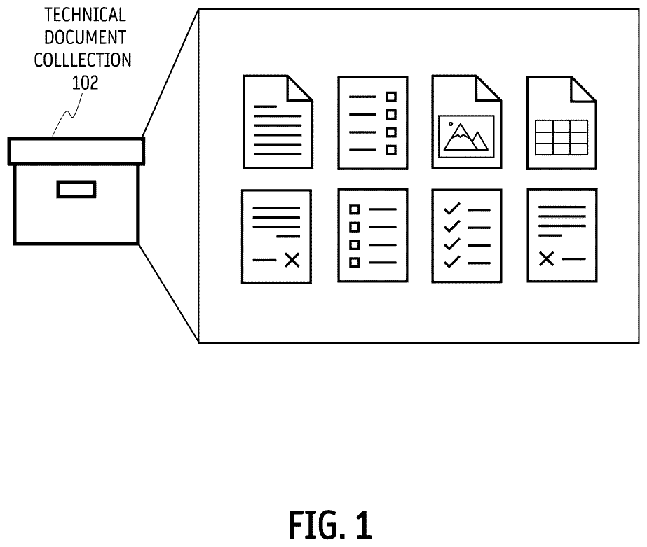

FIG. 1 illustrates technical document collection 102, according to some embodiments of the disclosure. Technical document collection 102 can include one or more documents, such as technical documents in various formats. Exemplary formats/files of technical document collection 102 can include: HyperText Markup Language (HTML) pages, extensible Markup Language (XML) files, YAML Ain′t Markup Language (YAML) files, Portable Document Format (PDF) files, Microsoft Word (DOC/DOCX) files, Microsoft PowerPoint (PPT/PPTX) files, Microsoft OneNote (.one) files, Microsoft Excel (XLS/XLSX) files, Comma-Separated Values (CSV) files, Tab-Separated Values (TSV) files, JavaScript Object Notation (JSON) records; source code files, Microsoft Visio (VSDX) files, draw.io/Diagrams.net files, image files, video files, audio files, Computer-Aided Design (CAD) files, circuit schematics, text files, Confluence/wiki pages, Jira or Azure DevOps (ADO) work items, GitHub Issues exports, meeting minutes, chat transcripts, and emails (Microsoft Outlook Message (MSG)/Electronic Mail (EML), log files including logs, metrics exports, monitoring dashboard exports, Structured Query Language (SQL) dumps, database (DB) snapshots, standards/specifications files, design specification files, test plans and reports files, release notes, etc. A document may carry structural anchors (e.g., headings, section numbers, tables of contents), cross-references (e.g., figure/table identifiers), layout cues (e.g., tables, equations), and metadata (e.g., source path, authorship, revision, timestamps, language, access labels, etc.).

Notably, the documents in technical document collection 102 are multimodal, meaning they have and integrate multiple types of information beyond plain text. For example, the documents include structured tables, diagrams, images, videos, equations, and code snippets alongside written explanations. This diversity in modality allows the documents to convey complex technical concepts using visual, textual, and even audio elements, often linking these modalities together through metadata and cross-references. Multimodal content can accurately represent technical knowledge, as it enables richer context and conveys meaning better than text alone.

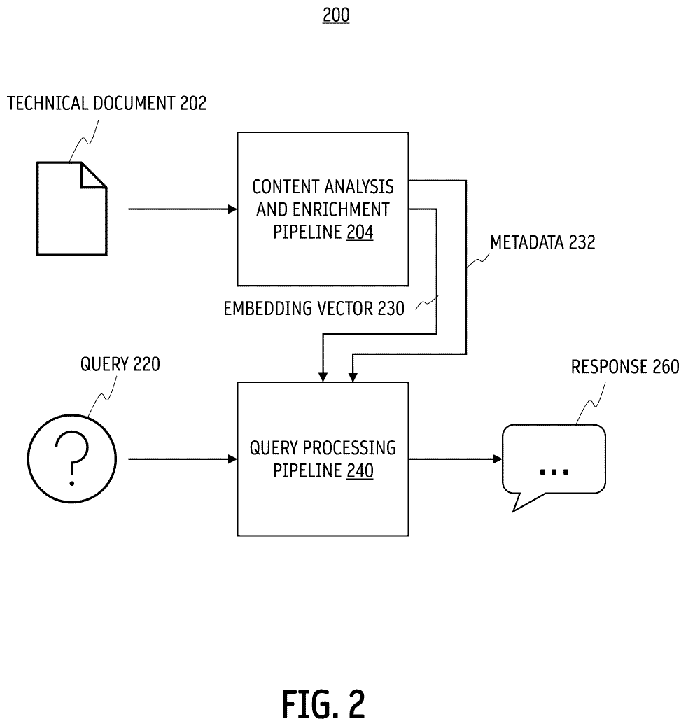

FIG. 2 illustrates context-oriented RAG system 200 comprising content analysis and enrichment pipeline 204 and query processing pipeline 240, according to some embodiments of the disclosure. Specifically, FIG. 2 illustrates the two-stage approach for tackling problems relating to other RAG systems with a structure-aware pipeline that enhances contextual understanding.

Content analysis and enrichment pipeline 204 transforms raw technical documents into contextually-enriched, structured representations. Content analysis and enrichment pipeline 204 can establish comprehensive contextual understanding through document parsing, media handling, and visual summarization with rich metadata and semantic relationships.

Content analysis and enrichment pipeline 204 can receive technical document 202 (e.g., from technical document collection 102 of FIG. 2). Technical document 202 has multimodal content. Content analysis and enrichment pipeline 204 can process many other technical documents. Content analysis and enrichment pipeline 204 can output embedding vector 230 and metadata 232. In many embodiments, technical document 202 can be separated into one or more chunks. In some embodiments, the one or more chunks can include at least one of: one or more chunks including at least one of: a textual content chunk, an image content chunk, and a table content chunk. Content analysis and enrichment pipeline 204 can generate and output one or more embedding vectors and metadata for each chunk (collectively shown as embedding vector 230 and metadata 232).

Embedding vector 230 can include a numerical representation of data such as a chunk. The data can include words, sentences, images, tables, etc. Embedding vector 230 can capture the semantic meaning and relationships within data in a format that machine learning models can process. Embedding vector 230 can include a fixed-length array of real numbers, where each dimension encodes specific features or patterns learned from large datasets. Embedding vector 230 can be generated by passing the data a machine learning model such as an encoder that has been trained to capture semantic information and relationships. The model transforms the data into a fixed-length array of real numbers, where similar inputs produce embedding vectors that are close together in the embedding space. This process enables efficient comparison and retrieval of content based on semantic meaning rather than just exact matches. In the context of technical documents, embedding vector 230 allows query processing pipeline 240 to efficiently and effectively to compare, retrieve, and analyze technical, multimodal content based on semantic meaning encoded in embedding vector 230 rather than just exact wording or format. By mapping diverse types of data into a shared mathematical embedding space, embedding vector 230 allows for efficient similarity search, clustering, and context-aware retrieval in query processing pipeline 240.

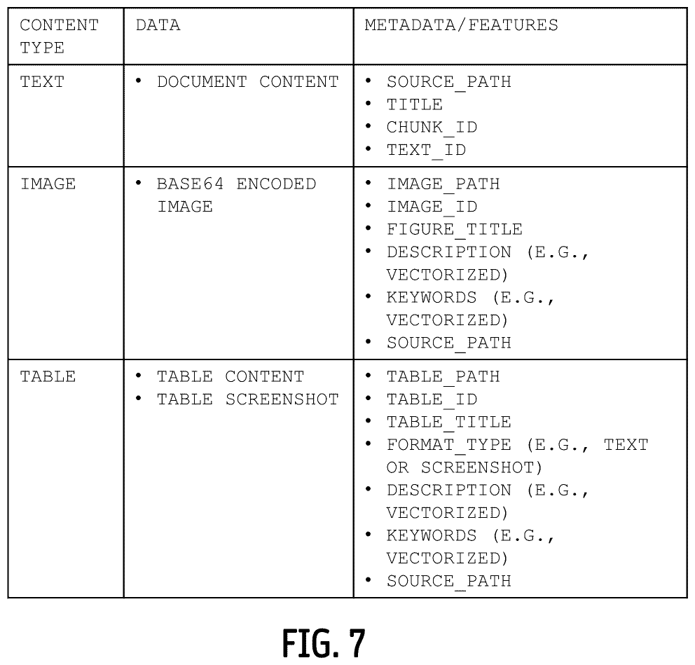

Metadata 232 can include comprehensive metadata for chunks in various modalities, e.g., textual content, image/visual content, and tabular content. One exemplary data structure for metadata 232 is depicted in FIG. 7. Examples of metadata 232 can include source paths, titles, IDs, vectorized descriptions, and format types for tables. Metadata 232 can ensure semantic relationships are preserved across content types. In some embodiments, metadata 232 can be generated by systematically extracting descriptive and contextual information from various content chunks during processing. For example, when parsing a content chunk, a metadata generator can identify and record attributes such as section titles, keywords, tags, authorship, timestamps, chunk IDs, parent-child relationships, and source paths. In the case of table content chunks or image content chunks, metadata 232 may include captions, figure numbers, cell coordinates, formatting details, and cross-references to related content. For various content chunks, the structure and content of each chunk can be analyzed systematically to generate attributes for metadata 232 to ensure that each chunk is enriched with context, making it easier to organize, retrieve, and understand within the document system.

Many documents such as technical document 202 and/or chunks extracted from the documents can be stored in the VDMS in query processing pipeline 240. Embedding vector 230 and metadata 232 produced by content analysis and enrichment pipeline 204 can be stored in the VDMS and used as indices to search and retrieve matching documents and/or chunks. The VDMS can efficiently handle vector embeddings, metadata, and multimodal data.

Query processing pipeline 240 leverages this enhanced context in the VDMS to identify relevant information and generate comprehensive, context-aware of responses while preserving semantic relationships across content types and modalities. Phrased differently, query processing pipeline 240 can leverage the enriched structural context produced by content analysis and enrichment pipeline 204 for precise retrieval of relevant documents and/or chunks and produce contextually grounded responses. Query processing pipeline 240 can receive query 220. Query processing pipeline 240 can utilize the VDMS storing a document collection that is indexed by embedding vector 230 and metadata 232 to retrieve one or more relevant documents and/or chunks. Query processing pipeline 240 can an LLM, e.g., a lightweight LLM, to generate response 260 to query 220 based on one or more documents retrieved using the VDMS.

Content analysis and enrichment pipeline 204 and query processing pipeline 240 together enable accurate analysis and contextual understanding of complex technical documentation.

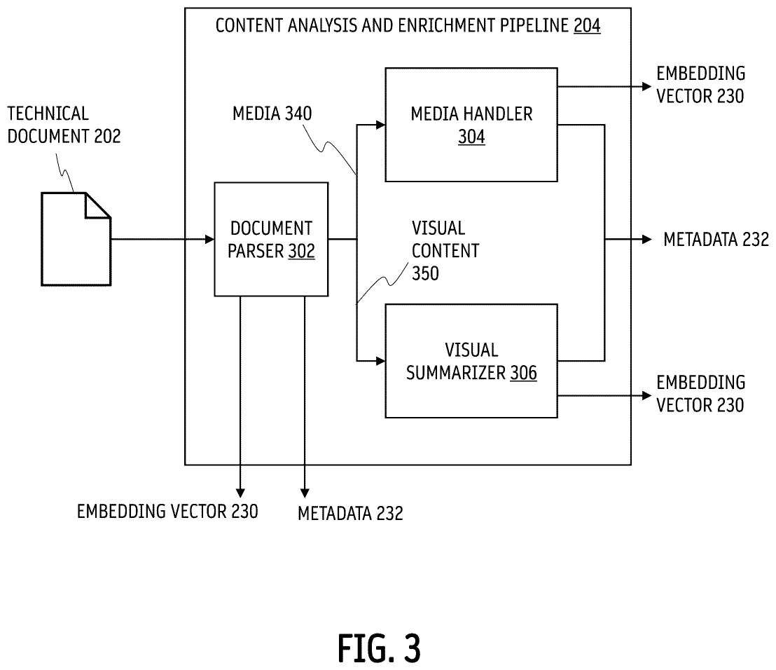

FIG. 3 illustrates content analysis and enrichment pipeline 204, according to some embodiments of the disclosure. Content analysis and enrichment pipeline 204 may include one or more of: document parser 302, media handler 304, and visual summarizer 306. Content analysis and enrichment pipeline 204 can convert raw documents such as technical document 202 into structured, metadata-rich, vectorized content.

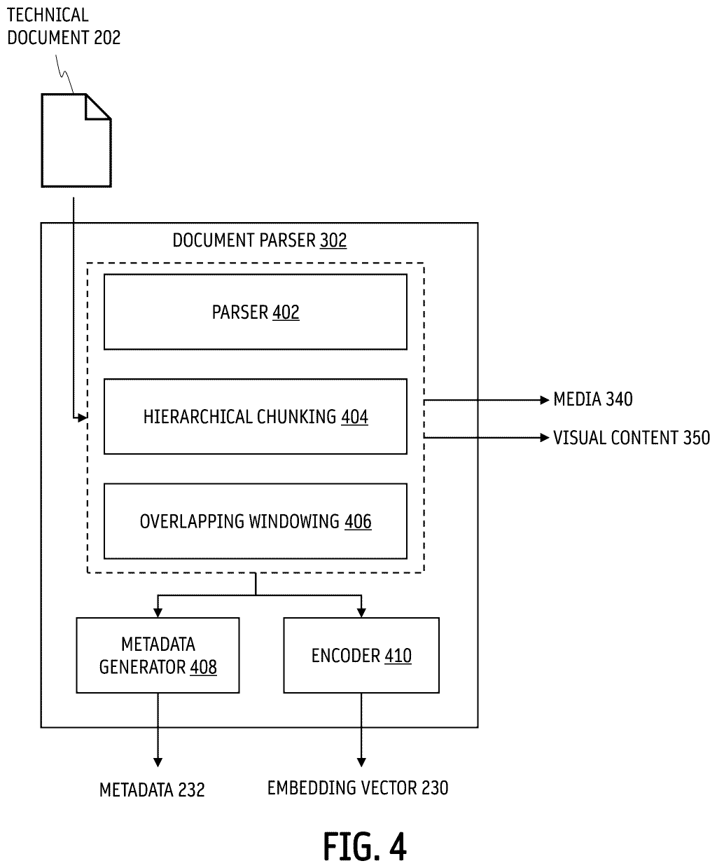

Document parser 302 breaks down documents such as technical document 202 into one or more segments referred to herein as content chunks or chunks, while preserving structural information about the chunks. Document parser 302 can produce vector 230 and metadata 232 for the one or more chunks of technical document 202. An implementation of document parser 302 is illustrated in FIG. 4.

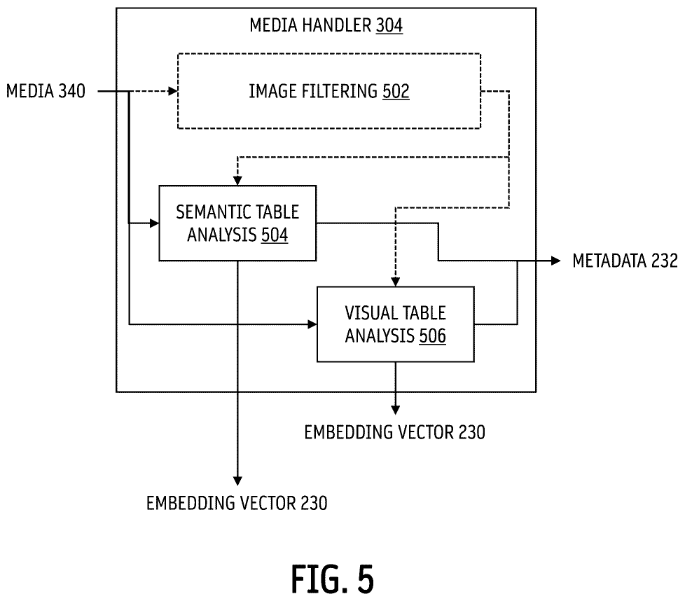

Media handler 304 can perform special handling for media 340, which can include certain types of chunks, such as media content chunks, multimedia content chunks, and/or table content chunks. Document parser 302 can forward media 340 for processing by media handler 304. Media handler 304 can receive media 340 and produce embedding vector 230 and metadata 232 for media 340. An implementation of media handler 304 is illustrated in FIG. 5.

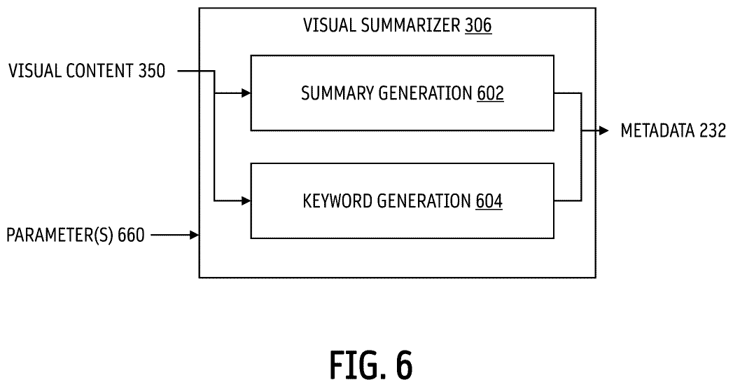

Visual summarizer 306 can perform special handling for visual content 350, which can include images and video, such as image content chunks. Document parser 302 can forward visual content 350 for processing by visual summarizer 306. Visual summarizer 306 can receive visual content 350 and produce embedding vector 230 and metadata 232 for visual content 350. An implementation of visual summarizer 306 is illustrated in FIG. 6.

FIG. 4 illustrates document parser 302, according to some embodiments of the disclosure. Document parser 302 can include parser 402 can parse a variety of documents and break the documents, e.g., technical document 202, into manageable chunks. Parser 402 can output one or more chunks including at least one of: a textual content chunk, an image content chunk, and a media/table content chunk. Parser 402 can extract different types of content from technical document 202 and identify embedded media such as images and tables from technical document 202.

Document parser 302 may further include hierarchical chunking 404. Hierarchical chunking 404 can break technical document 202 into chunks while preserving structural relationship information, such as hierarchical information, about the chunks. In some embodiments, hierarchical chunking 404 preserves structural information by assigning a chunk ID and a parent chunk ID to a chunk of the one or more chunks. The parent chunk ID can be a source path or a source ID. The chunk ID and the parent chunk ID can be output as part of metadata 232 for a particular chunk, such that the hierarchical relationship information can be captured. In some embodiments, hierarchical chunking 404 can divide technical document 202 into nested chunks and assigns each chunk a unique chunk ID along with a parent chunk ID as metadata. This approach preserves the hierarchical and structural relationships between different chunks, allowing the metadata to encapsulate and capture how sections, subsections, tables, and figures are organized within technical document 202. By maintaining the chunk ID and the parent chunk ID, hierarchical chunking 404 enables context-aware retrieval and analysis in the query processing pipeline, ensuring that the connections between related pieces of information are retained and can be leveraged during search or generation tasks. Moreover, the identifiers can create traceable links between related content chunks to ensure that relationships between content chunks are maintained throughout the content analysis and enrichment pipeline, facilitating accurate retrieval and context preservation in the query processing pipeline.

Document parser 302 may further include overlapping windowing 406. Overlapping windowing 406 can maintain contextual continuity during chunking or segmentation of technical document 202 by making sure that adjacent chunks overlap each other. Overlapping windowing 406 can extract a chunk of the one or more chunks from technical document 202 and extract a further chunk of the one or more chunks from technical document 202. The further chunk can overlap with the chunk by an overlap amount to ensure that semantic relationships between chunks are preserved. The overlap amount can be tunable, or a hyperparameter that can set to optimize one or more metrics. Overlapping windowing 406 can create adjacent chunks of technical document 202 with a specified overlap amount, meaning that each chunk shares a portion of its content with its neighboring chunks. This overlap ensures that contextual information at the boundaries is preserved and reduces the risk of losing meaning when dividing technical document 202. By maintaining continuity between chunks, overlapping windowing 406 supports more accurate retrieval and analysis, as queries can access information that spans across chunk boundaries.

For a textual content chunk, metadata generator 408 may produce metadata 232 for the textual content chunk, and encoder 410 may produce embedding vector 230 for the textual content chunk.

For an image content chunk, document parser 302 passes the image content chunk as visual content 350 to visual summarizer, such as visual summarizer 306 of FIG. 6. In some embodiments, for an image content chunk, metadata generator 408 may produce metadata 232 for the image content chunk, and encoder 410 may produce embedding vector 230 for the image content chunk.

For a media/table content chunk, document parser 302 passes the media/table content chunk as media 340 to media handler, such as media handler 304 of FIG. 5. In some embodiments, for a media/table content chunk, metadata generator 408 may produce metadata 232 for the media/table content chunk, and encoder 410 may produce embedding vector 230 for the media/table content chunk.

Embedding vector 230 and metadata 232 produced by document parser 302 can be stored in a VDMS.

FIG. 5 illustrates media handler 304, according to some embodiments of the disclosure. Media handler 304 may optionally include image filter 502 that evaluate media/table content chunks based on one or more quality assessment criteria that evaluate image resolution and clarity, and filter out low-quality visual content while preserving figure titles, captions, and related textual elements. Filtered media/images generated by image filter 502 may be forwarded to semantic table analysis 504 and/or visual table analysis 506 for further processing.

Media handler 304 processes table, media, and/or multimedia chunks from technical documents through a dual-stream approach while focusing on contextual relationships and structural integrity. The dual-stream approach involves semantic table analysis 504 and visual table analysis 506.

Semantic table analysis 504 processes a table/media content chunk (shown as media 340) as machine-readable text for semantic analysis. Semantic table analysis 504 can generate metadata 232 and/or embedding vector 230 for the text/media content chunk by processing the text of the table/media content chunk. Semantic table analysis 504 associates the table/media content chunk with contextual metadata, such as figure titles, captions, and cross-references, establishing semantic connections between visual and textual components.

In some embodiments, semantic table analysis 504 can convert a table/media content chunk into machine-readable text, enabling the extraction of meaningful metadata as metadata 232 and the generation of embedding vectors as embedding vector 230. The machine-readable text can include a semantic representation having machine-readable text of one or more of: table cell content, header row content, header column content, and table title content. By parsing table structures, such as titles, captions, headers, rows, columns, table cells, and extracting text accordingly, semantic table analysis 504 can capture relationships between data points and annotate one or more table cells with relevant contextual information as metadata 232. In some cases, semantic table analysis 504 may mathematically analyze the extracted text to derive high-level understanding of the tabular content and store the information as metadata 232. Semantic table analysis 504 effectively parse tabular data in table/media content chunks in a way that preserves both semantic content and layout structure. Semantic table analysis 504 can optionally generate embedding vector 230 based on the extracted text from the table structures for efficient retrieval, comparison, and integration of tabular data.

Visual table analysis 506 processes the table/media content chunk (shown as media 340) as visual screenshots to maintain structural information. Visual table analysis 506 can generate metadata 232 and/or embedding vector 230 for the text/media content chunk by processing the screenshot of the table/media content chunk. In some embodiments, visual table analysis 506 can implement one or more image standardization processes ensure format consistency across different screenshots while maintaining technical fidelity.

In some embodiments, visual table analysis 506 processes screenshots or images of table/media content chunks to preserve their layout, structure, and visual cues. The screenshot of the table content chunk can include a visual representation having one or more of: table layout, table cell content, header row content, header column content, and table title content. By capturing table/media content chunks as images or screenshots, visual table analysis 506 can retain important formatting details such as grid lines, merged cells, colors, and typographical emphasis that may be lost in plain text conversion. These visual representations, stored as embedding vector 230 can be linked to metadata 232, such as table titles, captions, or identifiers, enabling accurate association with the original document context. Visual table analysis 506 can ensure that spatial relationships and design elements useful for interpreting technical data are maintained, supporting more robust retrieval and understanding in technical, multimodal domain-specific systems.

In some embodiments, media handler 304 may extract a description and/or one or more keywords about the table/media content items, either through textual analysis and/or visual analysis. The description and/or one or more keywords may be vectorized and stored as metadata 232.

This integrated dual-stream approach of media handler 304 can maintain technical precision while supporting contextual analysis, enabling accurate information retrieval and response generation within the technical domain.

Embedding vector 230 and metadata 232 produced by semantic table analysis 504 and/or visual table analysis 506 can be stored in a VDMS.

FIG. 6 illustrates visual summarizer 306, according to some embodiments of the disclosure. Visual summarizer 306 can enhance image content chunks (shown as visual content 350) by generating detailed descriptions of visual content in technical documentation as metadata 232. In some embodiments, visual summarizer 306 can vectorized extracted metadata 232. Visual summarizer 306 can use one or more machine learning models to produce comprehensive descriptive summaries and semantic keywords for images and complex visualizations.

In some embodiments, visual summarizer 306 may include summary generation 602. Summary generation 602 may receive visual content 350, such as an image content chunk, and generate a summary describing the image content chunk. The summary can be generated through direct image analysis and/or text-based analysis of descriptions of the image content chunk, providing systematic handling of diverse visual content. The summary can capture contextual relationships such as figure titles and related text. The summary can be output as metadata 232 for the image content chunk to enrich the image content chunk. The summary can be optionally vectorized. In some embodiments, the summary can be vectorized alongside the image content chunk to integrate visual and textual relationships in a semantic embedding space.

In some embodiments, visual summarizer 306 may include keyword generation 604. Keyword generation 604 may receive visual content 350, such as an image content chunk, and generate one or more keywords or tags about the image content chunk. The keywords can be generated through direct image analysis and/or text-based analysis of descriptions of the image content chunk, providing systematic handling of diverse visual content. The keywords can capture salient information about the image content chunk and contextual relationships such as figure titles and related text. The keywords can be output as metadata 232 for the image content chunk to enrich the image content chunk. The keywords can be optionally vectorized. In some embodiments, the keywords can be vectorized alongside the image content chunk to integrate visual and textual relationships in a semantic embedding space.

In some embodiments, summary generation 602 and/or keyword generation 604 can be configurable using one or more parameters 660. Configurable parameters 660 may tune or configure the level of detail and/or technical specificity of the generated summaries and/or keywords. Configurable parameters 660 may be adjusted based on one or more metrics. In some embodiments, summary generation 602 and/or keyword generation 604 may produce different sets of summaries and/or keywords produced using different values for configurable parameters 660 to ensure that summaries and/or keywords are produced at varying levels of generality.

Visual summarizer 306 can enrich image content chunks by maintaining contextual relationships by extracting and preserving figure titles, related text, and technical metadata during the summarization and keyword extraction process. In some cases, the resulting summaries and keywords are vectorized alongside the image content chunks to establish a semantic embedding space that integrates visual and textual relationships. This integrated approach enables context-aware retrieval of visual content in response to technical queries, while maintaining the precise technical nature of the documentation.

FIG. 7 illustrates exemplary metadata for different types of content chunks, according to some embodiments of the disclosure. The metadata illustrates digital structural features/attributes that can facilitate document retrieval. The metadata can be stored in a graph store of a VDMS to allow for filtering of content and find relevant content more easily.

The features can include chunk IDs (e.g., as CHUNK_ID) and parent chunk IDs (e.g., as SOURCE_PATH) to capture hierarchical relationships of various chunks within a document. The features can include vectorized representations of the chunks (e.g., as DESCRIPTION) and other metadata attributes to capture the structure and semantics of the content, such as text, figures, tables, and equations. The features can include a format type indicating whether a table content chunk corresponds to table text or table screenshot.

For text content chunks, the metadata can include one or more of: SOURCE_PATH, TITLE, CHUNK_ID, and TEXT_ID. In some embodiments, SOURCE_PATH may include the file path or location within the original document where the text content chunk is sourced. This attribute links the chunk back to its parent document or parent chunk, preserving hierarchical relationships. In some embodiments, TITLE may include the section or heading title associated with the text chunk, providing semantic context and aiding in navigation and retrieval. In some embodiments, CHUNK_ID may indicate a unique identifier assigned to each text content chunk, ensuring traceability and enabling the system to reconstruct document structure during retrieval. In some embodiments, TEXT_ID may include an ID for the specific text content chunk, which may be used to distinguish between multiple text content chunks within the same parent chunk or document.

For image content chunks, the metadata can include one or more of: IMAGE_PATH, IMAGE_ID, FIGURE_TITLE, DESCRIPTION, KEYWORDS, and SOURCE_PATH. In some embodiments, IMAGE_PATH may include the file path or location of the image content chunk within the source document, allowing the system to reference and retrieve the image content chunk in context. In some embodiments, IMAGE_ID may include a unique identifier for each image content chunk, supporting precise indexing and retrieval. In some embodiments, FIGURE_TITLE may include the caption or title associated with the image content chunk, which provides descriptive context and links the image to relevant textual content. In some embodiments, DESCRIPTION may include a vectorized summary or semantic description of the image content chunk, generated by one or more machine learning models to capture the content and meaning of the image content chunk for retrieval and answer generation. In some embodiments, KEYWORDS may include semantic tags or keywords extracted from the image content chunk or its description, facilitating search and filtering based on visual or conceptual features. In some embodiments, SOURCE_PATH may include the file path or location in the original document where the image content chunk appears, maintaining the relationship between the image content chunk and its surrounding content.

For table/media content chunks, the metadata can include one or more of TABLE_PATH, TABLE_ID, TABLE_TITLE, FORMAT_TYPE, DESCRIPTION, KEYWORDS, and SOURCE_PATH. In some embodiments, TABLE_PATH may include the file path or location of the table content chunk within the source document, enabling hierarchical linking and context preservation. In some embodiments, TABLE_ID may include a unique identifier for each table, supporting accurate indexing and retrieval. In some embodiments, TABLE_TITLE may include the caption or title associated with the table content chunk, providing semantic context and aiding in understanding the table's purpose. In some embodiments, FORMAT_TYPE may specify the format of the table content chunk, such as text or screenshot, indicating whether the table content chunk is stored as machine-readable text or as a visual image to preserve layout fidelity. In some embodiments, DESCRIPTION may include a vectorized summary or semantic description of the table content chunk, capturing its content and relationships for retrieval and answer generation. In some embodiments, KEYWORDS may include semantic tags or keywords extracted from the table content chunk or its description, facilitating targeted search and filtering. In some embodiments, SOURCE_PATH may include the file path or location in the original document where the table content chunk appears, maintaining its contextual relationship with other content chunks in the document.

The metadata can be organized within a content graph or database of a VDMS, where content chunks are annotated with the metadata and linked to the embedding vectors that capture the semantic meaning of the content chunks. Advantageously, the retrieval of documents from the VDMS can leverage the embedding vectors and the metadata together for accurate retrieval and contextual understanding of domain-specific documents.

Herein, vectorization of description and/or keyword(s) can include a process of converting the text into numerical representations (e.g., one or more vectors) that can be processed by machine learning models or search systems. The vectors can capture the semantic meaning of the text to enable algorithms to perform tasks such as semantic search, clustering, classification, and make recommendations. Vectorization can convert the text to a common semantic embedding space to allow algorithms to understand the semantic meaning of the text efficiently and effectively. Vectorization can compress the text data into dense, lower-dimensional formats that are easier to process and analyze. Moreover, vectorized representations of description and/or keyword(s) can be used to find matches in the VDMS easily where the matches can be ranked by semantic similarity rather than exact keyword matches.

### Query Processing Pipeline

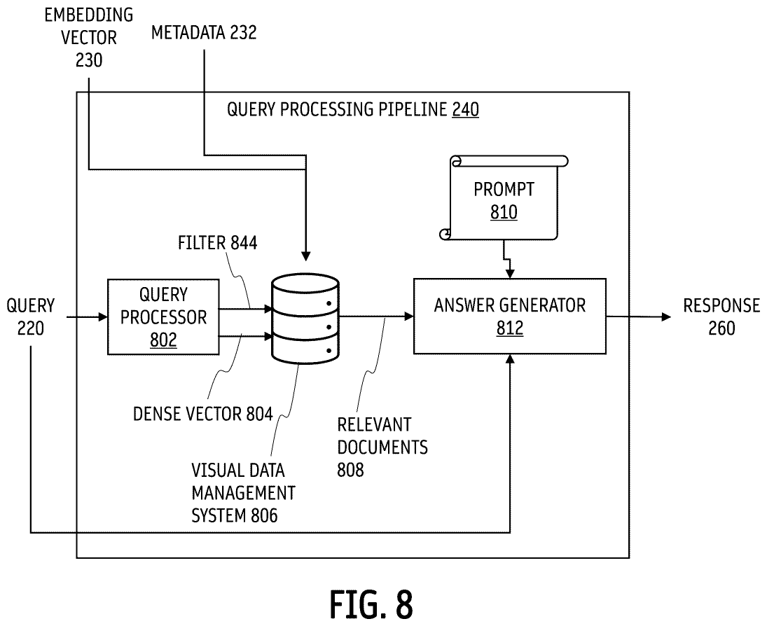

FIG. 8 illustrates query processing pipeline 240, according to some embodiments of the disclosure. Query processing pipeline 240 includes query processor 802, VDMS 806, and answer generator 812. Query processing pipeline 240 uses a RAG approach to transform user queries into dense vectors and filters, to enable semantic consistency with document embeddings for efficient similarity-based retrieval.

Query processor 802 may receive query 220, which can be a natural language query. Query 220 may include a question or information request posed by a user. Query 220 can serve as the input to query processing pipeline 240.

Query processor 802 may generate dense vector 804, which is a vector embedding representation of query 220. Dense vector 804 may be generated by transforming query 220 into a dense vector representation using encoders and/or embedding models. Dense vector 804 can encode the semantic meaning of the query to enable similarity-based retrieval from embedding vectors stored in a vector store of VDMS 806.

Query processor 802 may generate filter 844, which may be used to perform a filtering query on metadata stored in a graph store of VDMS 806. Filter 844 can impose one or more constraints or filters on the retrieval process and ensure that relevant documents and/or chunks matching one or more criteria specified in filter 844 are returned. Filter 844 can include metadata criteria, content type, relevance). Filter 844 can be generated based on query 220, using one or more models that may extract intended criteria in query 220.

Query processing pipeline 240 inputs the dense vector 804 and optionally filter 844 into VDMS 806 that stores multimodal data indexed by metadata 232 and embedding vector 230. Metadata 232 can encode hierarchical information about multimodal content of a document collection. VDMS 806 may act as the multimodal vector store, containing hierarchically chunked, metadata-rich representations of text, images, and tables. VDMS 806 can be used to perform vector similarity search between dense vector 804 and stored embedding vector 230, optionally filter by filter 844, and retrieve the most relevant content, as one or more relevant documents 808, using a top-K strategy, such as a top-5 strategy. One or more relevant documents 808 can include one or more content chunks (e.g., having textual content chunk, image content chunk, media/table content chunk, etc.) and/or one or more documents that are most relevant to query 220. In some cases, one or more relevant documents 808 can include one or more content chunks (e.g., having textual content chunk, image content chunk, media/table content chunk, etc.) that are most relevant to query 220 and one or more source documents of the one or more content chunks. In some cases, one or more relevant documents 808 can include one or more source documents of one or more content chunks one or more content chunks (e.g., having textual content chunk, image content chunk, media/table content chunk, etc.) that are most relevant to query 220. One or more relevant documents 808 thus provide comprehensive context and domain-specific knowledge for answer generation, integrating both textual and visual information.

VDMS 806 can enable efficient retrieval of multimodal technical content by leveraging dense vector representations of text, tables, and visuals stored during content analysis. Using inner product distance metrics, VDMS 806 can perform similarity computations between dense vector 804 and embedding vector 230 associated with various content chunks in a vector store of VDMS 806. In some cases, VDMS 806 may implement a configurable top-K retrieval strategy to select the most semantically relevant documents and output the top-K content chunks and/or documents as one or more relevant documents 808. In some embodiments, one or more relevant documents 808 further includes the metadata associated with the top-K content chunks and/or documents. One or more relevant documents 808 matching query 220, represented by dense vector 804 and optionally filter 844, can be produced through searching metadata 232 and embedding vector 230 of VDMS 806 using dense vector 804 and optionally filter 844. VDMS 806 can handle both unimodal and multimodal queries as query 220 effectively. The retrieved context, e.g., one or more relevant documents 808, provides comprehensive context for answer generator 812 to produce response 260, integrating insights from both textual and visual sources.

Answer generator 812 can receive one or more relevant documents 808 from VDMS 806 and query 220. Answer generator 812 may include a large language model, such as a multimodal LLM, that can synthesize or generate response 260 to query 220 based on one or more relevant documents 808 as the retrieved context.

Leveraging the retrieved context, answer generator 812 can generate a contextually grounded, accurate answer that reflects both the semantic and structural relationships in the source material.

In some embodiments, answer generator 812, e.g., the LLM therein, may receive prompt 810. Prompt 810 may include a tailored prompt constructed for answer generator 812 to guide the LLM therein to consider document structure, metadata, and multimodal elements. Prompt 810 can ensure the LLM analyzes not just the raw content in the retrieved context, but also the relationships, layout, and technical terminology present in the retrieved context.

In some embodiments, prompt 810 may include one or more instructions to the LLM in answer generator 812 to perform one or more of the following: consider document structure, consider visual elements, analyze table layout, consider data relationships, and consider technical terminology. In some embodiments, prompt 810 may include instructions to the LLM in answer generator 812 to consider both document structure and visual elements. In some embodiments, prompt 810 may include instructions to the LLM in answer generator 812 to analyze structural layout of tables, data relationships of tables, and patterns in the table, to ensure comprehensive understanding of tabular information. In some embodiments, prompt 810 may include instructions to the LLM in answer generator 812 to consider special technical terminology and consistency with documentation with a specific standardization body.

Leveraging the retrieved context and prompt 810, answer generator 812 can synthesize response 260 that are firmly anchored in the underlying source material. Response 260 can reflect not only the semantic meaning of the technical content but also its structural relationships, such as the organization of information and connections between various content chunks. As a result, answer generator 812 can produce accurate, relevant responses that are contextually-aware, drawing upon both the explicit content in the content chunks and the metadata that describe relationships and semantic meaning within the document collection.

Answer generator 812 can synthesize response 260 by combining retrieved context, e.g., one or more relevant documents 808, even when the context includes multimodal content. Retrieved context is processed by answer generator 812 to preserve textual structure and semantic relationships. In some cases, answer generator 812 may leverage the metadata as part of retrieved context to produce response 260. For some queries, answer generator 812 may perform additional analysis and/or reasoning to align and/or enhance response 260 to one or more requests made in the query. For some queries requesting citations to supporting evidence, answer generator 812 may produce response 260 with explicit links to supporting documents by leveraging the metadata in the retrieved context.

### Methods for Context-Aware and Efficient RAG for Domain-Specific Scenarios

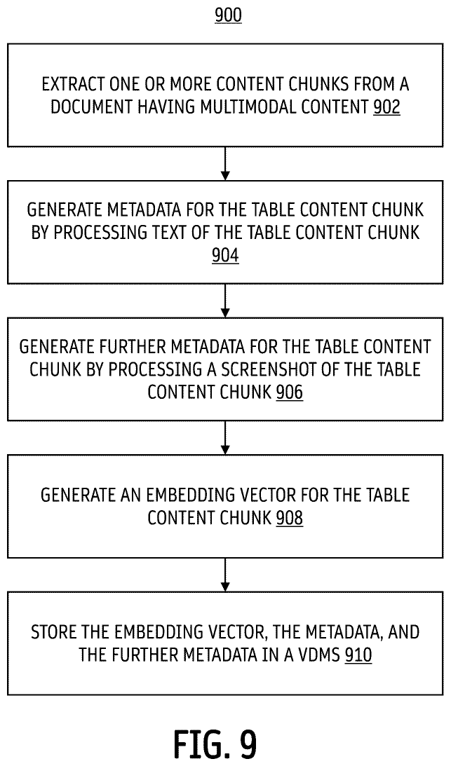

FIG. 9 depicts a flow diagram illustrating method 900 for processing a document collection, according to some embodiments of the disclosure. Method 900 can be performed by one or more components of content analysis and enrichment pipeline 204 illustrated in the FIGS.

In 902, one or more content chunks are extracted from a document having multimodal content. The one or more content chunks can include at least one of: a textual content chunk, an image content chunk, and a table content chunk.

In 904, metadata for the table content chunk can be generated by processing text of the table content chunk.

In 906, further metadata for the table content chunk can be generated by processing a screenshot of the table content chunk.

In 908, an embedding vector for the table content chunk can be generated.

In 910, the embedding vector, the metadata, and the further metadata are stored in a visual data management system.

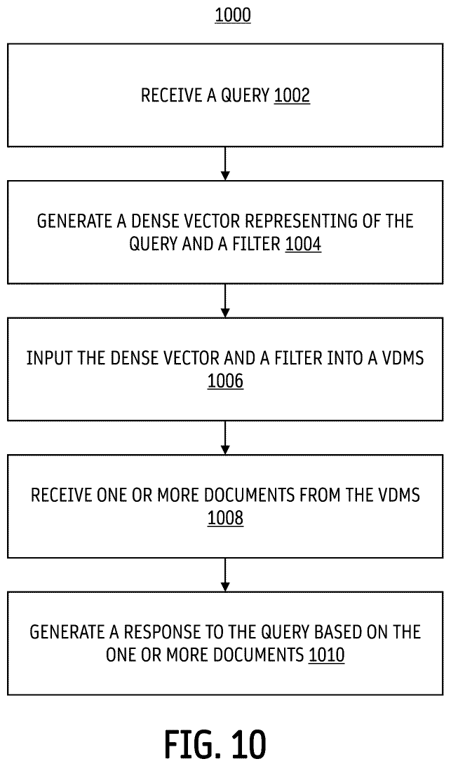

FIG. 10 depicts a flow diagram illustrating method 1000 for generating a response to a query, according to some embodiments of the disclosure. Method 1000 can be performed by one or more components of query processing pipeline 240 illustrated in the FIG.

In 1002, a query is received.

In 1004, a dense vector representation of the query and a filter are generated.

In 1006, the dense vector and the filter are input into a visual data management system that stores metadata and embedding vectors. The metadata can encode hierarchical information about multimodal content of the document collection. The metadata and embedding vectors are used as indices for content chunks and documents of the document collection.

In 1008, one or more documents from the visual data management system that match the dense vector and the filter are received. The one or more documents can be retrieved by the visual data management system using the dense vector and the filter, by searching through the metadata and the embedding vectors in the visual data management system. In some embodiments, the one or more documents may include one or more content chunks that match the dense vector and the filter.

In 1010, a response to the query is generated based on the one or more documents. In some cases, the response to the query is generated based on the one or more chunks.

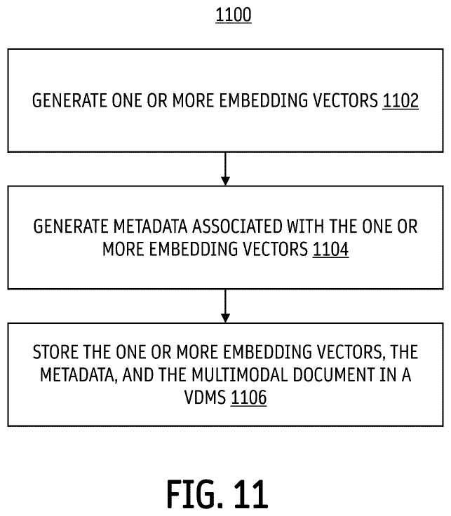

FIG. 11 depicts a flow diagram illustrating a method for processing a document collection, according to some embodiments of the disclosure. Method 11 00 can be performed by one or more components of content analysis and enrichment pipeline 204 illustrated in the FIGS.

In 1102, one or more embedding vectors are generated by analyzing a multimodal document having one or more types of content.

In 1104, metadata associated with the one or more embedding vectors of the multimodal document is generated.

In 1106, the one or more embedding vectors, the metadata, and the multimodal document are stored in a visual data management system.

### Exemplary Computing Device

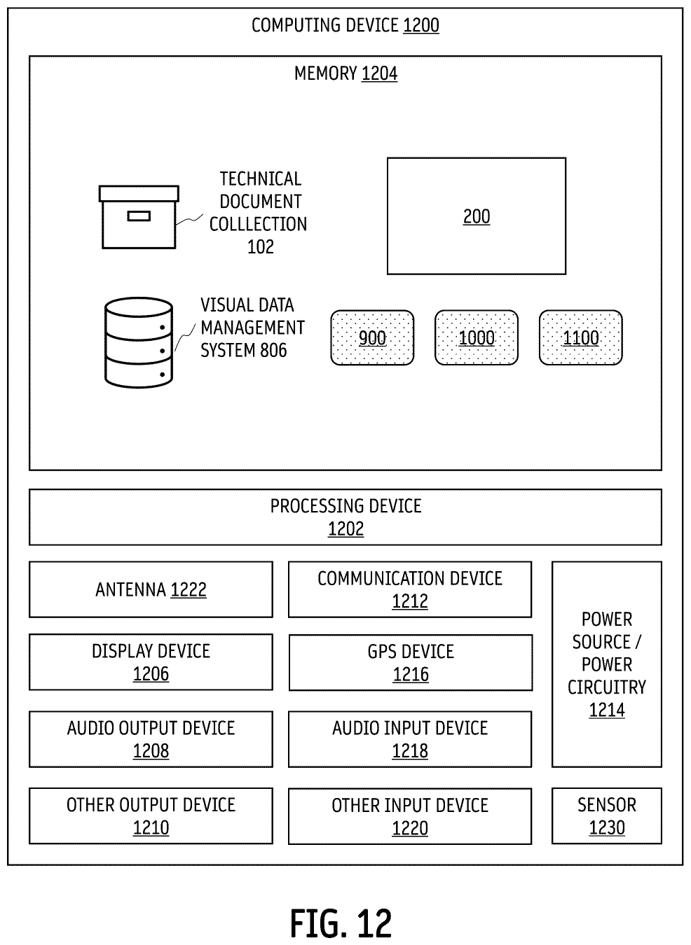

FIG. 12 is a block diagram of an apparatus or a system, e.g., an exemplary computing device 1200, according to some embodiments of the disclosure. One or more computing devices 1200 may be used to implement the functionalities described with the FIGS. and herein. A number of components illustrated in FIG. 12 can be included in computing device 1200, but any one or more of these components may be omitted or duplicated, as suitable for the application. In some embodiments, some or all of the components included in computing device 1200 may be attached to one or more motherboards. In some embodiments, some or all of these components are fabricated onto a single system on a chip (SoC) die. Additionally, in various embodiments, computing device 1200 may not include one or more of the components illustrated in FIG. 12, and computing device 1200 may include interface circuitry for coupling to the one or more components. For example, computing device 1200 may not include display device 1206, and may include display device interface circuitry (e.g., a connector and driver circuitry) to which a display device 1206 may be coupled. In another set of examples, computing device 1200 may not include audio input device 1218 or an audio output device 1208 and may include audio input or output device interface circuitry (e.g., connectors and supporting circuitry) to which an audio input device 1218 or audio output device 1208 may be coupled.

Computing device 1200 may include processing device 1202 (e.g., one or more processing devices, one or more of the same types of processing device, one or more of different types of processing device). Processing device 1202 may include electronic circuitry that processes electronic data from data storage elements (e.g., registers, memory, resistors, capacitors, quantum bit cells) to transform that electronic data into other electronic data that may be stored in registers and/or memory. Examples of processing device 1202 may include a CPU, a GPU, a quantum processor, a machine learning processor, an artificial intelligence processor, a neural network processor, a neural processing unit (NPU), an artificial intelligence accelerator, an application-specific integrated circuit (ASIC), an analog signal processor, an analog computer, a microprocessor, a digital signal processor, a field-programmable gate array (FPGA), a tensor processing unit (TPU), a data processing unit (DPU), etc.

Computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1204 includes one or more non-transitory computer readable storage media. In some embodiments, memory 1204 may include memory that shares a die with the processing device 1202. Memory 1204 may store machine-readable instructions, and processing device 1202 may execute the machine-readable instructions.

In some embodiments, memory 1204 includes one or more non-transitory computer readable media storing instructions executable to perform operations described with the FIGS. and herein, such as the methods and operations illustrated in the FIGS. In some embodiments, memory 1204 includes one or more non-transitory computer readable media storing instructions executable to perform one or more operations illustrated in FIGS. 2-6 and 8. In some embodiments, memory 1204 includes one or more non-transitory computer readable media storing instructions executable to perform one or more operations of method 900 of FIG. 9. In some embodiments, memory 1204 includes one or more non-transitory computer readable media storing instructions executable to perform one or more operations of method 1000 of FIG. 10. In some embodiments, memory 1204 includes one or more non-transitory computer readable media storing instructions executable to perform one or more operations of method 1100 of FIG. 11. Memory 1204 may store instructions that encode one or more exemplary parts, such as one or more components of context-oriented RAG system 200. For instance, memory 1204 may store instructions that encode one or more exemplary parts, such as one or more components of illustrated in FIGS. 2-6 and 8. The instructions stored in the one or more non-transitory computer readable media may be executed by processing device 1202.

In some embodiments, memory 1204 may store data, e.g., data structures, binary data, bits, metadata, files, blobs, etc., as described with the FIGS. and herein. For example, memory 1204 may include one or more of: technical document collection 102, and VDMS 806. Memory 1204 may store data received and/or generated by parts such as one or more components of context-oriented RAG system 200 and one or more components of illustrated in FIGS. 2-6 and 8.

In some embodiments, computing device 1200 may include a communication device 1212 (e.g., one or more communication devices). For example, the communication device 1212 may be configured for managing wired and/or wireless communications for the transfer of data to and from computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1212 may implement any of a number of wireless standards or protocols, including but not limited to Institute for Electrical and Electronic Engineers (IEEE) standards including Wi-Fi (IEEE 1202.10 family), IEEE 1202.16 standards (e.g., IEEE 1202.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 1202.16 compatible Broadband Wireless Access (BWA) networks are generally referred to as WiMAX networks, an acronym that stands for worldwide interoperability for microwave access, which is a certification mark for products that pass conformity and interoperability tests for the IEEE 1202.16 standards. Communication device 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. Communication device 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication device 1212 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1212 may operate in accordance with other wireless protocols in other embodiments. Computing device 1200 may include an antenna 1222 to facilitate wireless communications and/or to receive other wireless communications (such as radio frequency transmissions). Computing device 1200 may include receiver circuits and/or transmitter circuits. In some embodiments, the communication device 1212 may manage wired communications, such as electrical, optical, or any other suitable communication protocols (e.g., the Ethernet). As noted above, the communication device 1212 may include multiple communication chips. For instance, a first communication device 1212 may be dedicated to shorter-range wireless communications such as Wi-Fi or Bluetooth, and a second communication device 1212 may be dedicated to longer-range wireless communications such as global positioning system (GPS), EDGE, GPRS, CDMA, WiMAX, LTE, EV-DO, or others. In some embodiments, a first communication device 1212 may be dedicated to wireless communications, and a second communication device 1212 may be dedicated to wired communications.

Computing device 1200 may include power source/power circuitry 1214. The power source/power circuitry 1214 may include one or more energy storage devices (e.g., batteries or capacitors) and/or circuitry for coupling components of computing device 1200 to an energy source separate from computing device 1200 (e.g., DC power, AC power, etc.).

Computing device 1200 may include a display device 1206 (or corresponding interface circuitry, as discussed above). Display device 1206 may include any visual indicators, such as a heads-up display, a computer monitor, a projector, a touchscreen display, a liquid crystal display (LCD), a light-emitting diode display, or a flat panel display, for example.

Computing device 1200 may include an audio output device 1208 (or corresponding interface circuitry, as discussed above). The audio output device 1208 may include any device that generates an audible indicator, such as speakers, headsets, or earbuds, for example.

Computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

Computing device 1200 may include a GPS device 1216 (or corresponding interface circuitry, as discussed above). GPS device 1216 may be in communication with a satellite-based system and may receive a location of computing device 1200, as known in the art.

Computing device 1200 may include a sensor 1230 (or one or more sensors). Computing device 1200 may include corresponding interface circuitry, as discussed above). Sensor 1230 may sense physical phenomenon and translate the physical phenomenon into electrical signals that can be processed by, e.g., processing device 1202. Examples of sensor 1230 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 1200 may include another output device 1210 (or corresponding interface circuitry, as discussed above). Examples of the other output device 1210 may include an audio codec, a video codec, a printer, a wired or wireless transmitter for providing information to other devices, haptic output device, gas output device, vibrational output device, lighting output device, home automation controller, or an additional storage device.

Computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1200 may have any desired form factor, such as a handheld or mobile computer system (e.g., a cell phone, a smart phone, a mobile Internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, computing device 1200 may be any other electronic device that processes data.

### Select Examples

Example 1 provides an apparatus, including one or more memories storing machine-readable instructions; and one or more computer processors, when executing the machine-readable instructions, are to perform operations including: generating one or more embedding vectors by analyzing a multimodal document having one or more types of content; generating metadata associated with the one or more embedding vectors of the multimodal document; and storing the one or more embedding vectors, the metadata, and the multimodal document in a visual data management system.

Example 2 provides the apparatus of example 1, where analyzing the multimodal document includes parsing the multimodal document into one or more content chunks, the one or more content chunks including at least one of: a textual content chunk, an image content chunk and a table content chunk.

Example 3 provides the apparatus of example 2, where generating the one or more embedding vectors includes generating the one or more embedding vectors by processing the one or more content chunks.

Example 4 provides the apparatus of example 2 or 3, where generating the metadata includes determining the metadata by processing the one or more content chunks.

Example 5 provides the apparatus of any one of examples 2-4, where generating the one or more embedding vectors includes generating an embedding vector for the table content chunk by processing text of the table content chunk; and generating an additional embedding vector for the table content chunk by processing a screenshot of the table content chunk.

Example 6 provides the apparatus of example 5, where the text of the table content chunk includes a semantic representation having machine-readable text of one or more of: table cell content, header row content, header column content, and table title content.

Example 7 provides the apparatus of example 5 or 6, where the screenshot of the table content chunk includes a visual representation having one or more of: table layout, table cell content, header row content, header column content, and table title content.

Example 8 provides the apparatus of any one of examples 2-7, where generating the metadata includes generating one or more keywords describing content of a content chunk of the one or more content chunks.

Example 9 provides the apparatus of example 8, where generating the metadata includes generating a vectorized representation of the one or more keywords.

Example 10 provides the apparatus of any one of examples 2-9, where generating the metadata includes generating a summary describing content of a content chunk of the one or more content chunks.

Example 11 provides the apparatus of example 10, where generating the metadata includes generating a vectorized representation of the summary.

Example 12 provides the apparatus of any one of examples 2-11, where generating the metadata includes assigning a chunk identifier and a parent chunk identifier to a content chunk of the one or more content chunks.

Example 13 provides the apparatus of any one of examples 1-12, where analyzing the multimodal document includes extracting a content chunk from the multimodal document; and extracting a further content chunk from the multimodal document, where the further content chunk overlaps with the content chunk by an overlap amount.

Example 14 provides the apparatus of any one of examples 1-13, where the visual data management system includes a graph store to store the metadata; and a vector store to store the one or more embedding vectors.

Example 15 provides one or more non-transitory computer readable media including instructions, that when executed by one or more processors, cause the one or more processors to perform operations including generating one or more embedding vectors by analyzing a multimodal document having one or more types of content; generating metadata associated with the one or more embedding vectors of the multimodal document; and storing the one or more embedding vectors, the metadata, and the multimodal document in a visual data management system.

Example 16 provides the one or more non-transitory computer readable media of example 15, where analyzing the multimodal document includes parsing the multimodal document into one or more content chunks, the one or more content chunks including at least one of: a textual content chunk, an image content chunk and a table content chunk.

Example 17 provides the one or more non-transitory computer readable media of example 16, where generating the one or more embedding vectors includes generating the one or more embedding vectors by processing the one or more content chunks.

Example 18 provides the one or more non-transitory computer readable media of example 16 or 17, where generating the metadata includes determining the metadata by processing the one or more content chunks.

Example 19 provides the one or more non-transitory computer readable media of any one of examples 16-18, where generating the one or more embedding vectors includes generating an embedding vector for the table content chunk by processing text of the table content chunk; and generating an additional embedding vector for the table content chunk by processing a screenshot of the table content chunk.

Example 20 provides the one or more non-transitory computer readable media of example 19, where the text of the table content chunk includes a semantic representation having machine-readable text of one or more of: table cell content, header row content, header column content, and table title content.

Example 21 provides the one or more non-transitory computer readable media of example 19 or 20, where the screenshot of the table content chunk includes a visual representation having one or more of: table layout, table cell content, header row content, header column content, and table title content.

Example 22 provides the one or more non-transitory computer readable media of any one of examples 16-21, where generating the metadata includes generating one or more keywords describing content of a content chunk of the one or more content chunks.

Example 23 provides the one or more non-transitory computer readable media of example 22, where generating the metadata includes generating a vectorized representation of the one or more keywords.

Example 24 provides the one or more non-transitory computer readable media of any one of examples 16-23, where generating the metadata includes generating a summary describing content of a content chunk of the one or more content chunks.

Example 25 provides the one or more non-transitory computer readable media of example 24, where generating the metadata includes generating a vectorized representation of the summary.

Example 26 provides the one or more non-transitory computer readable media of any one of examples 16-25, where generating the metadata includes assigning a chunk identifier and a parent chunk identifier to a content chunk of the one or more content chunks.

Example 27 provides the one or more non-transitory computer readable media of any one of examples 15-26, where analyzing the multimodal document includes extracting a content chunk from the multimodal document; and extracting a further content chunk from the multimodal document, where the further content chunk overlaps with the content chunk by an overlap amount.

Example 28 provides the one or more non-transitory computer readable media of any one of examples 15-27, where the visual data management system includes a graph store to store the metadata; and a vector store to store the one or more embedding vectors.

Example 29 provides a method, including generating one or more embedding vectors by analyzing a multimodal document having one or more types of content; generating metadata associated with the one or more embedding vectors of the multimodal document; and storing the one or more embedding vectors, the metadata, and the multimodal document in a visual data management system.

Example 30 provides the method of example 29, where analyzing the multimodal document includes parsing the multimodal document into one or more content chunks, the one or more content chunks including at least one of: a textual content chunk, an image content chunk and a table content chunk.

Example 31 provides the method of example 30, where generating the one or more embedding vectors includes generating the one or more embedding vectors by processing the one or more content chunks.

Example 32 provides the method of example 30 or 31, where generating the metadata includes determining the metadata by processing the one or more content chunks.

Example 33 provides the method of any one of examples 30-32, where generating the one or more embedding vectors includes generating an embedding vector for the table content chunk by processing text of the table content chunk; and generating an additional embedding vector for the table content chunk by processing a screenshot of the table content chunk.

Example 34 provides the method of example 33, where the text of the table content chunk includes a semantic representation having machine-readable text of one or more of: table cell content, header row content, header column content, and table title content.

Example 35 provides the method of example 33 or 34, where the screenshot of the table content chunk includes a visual representation having one or more of: table layout, table cell content, header row content, header column content, and table title content.

Example 36 provides the method of any one of examples 30-35, where generating the metadata includes generating one or more keywords describing content of a content chunk of the one or more content chunks.

Example 37 provides the method of example 36, where generating the metadata includes generating a vectorized representation of the one or more keywords.

Example 38 provides the method of any one of examples 30-37, where generating the metadata includes generating a summary describing content of a content chunk of the one or more content chunks.

Example 39 provides the method of example 38, where generating the metadata includes generating a vectorized representation of the summary.

Example 40 provides the method of any one of examples 30-39, where generating the metadata includes assigning a chunk identifier and a parent chunk identifier to a content chunk of the one or more content chunks.

Example 41 provides the method of any one of examples 29-40, where analyzing the multimodal document includes extracting a content chunk from the multimodal document; and extracting a further content chunk from the multimodal document, where the further content chunk overlaps with the content chunk by an overlap amount.

Example 42 provides the method of any one of examples 29-41, where the visual data management system includes a graph store to store the metadata; and a vector store to store the one or more embedding vectors.

Example 43 provides an apparatus including means for performing a method according to any one of examples 29-42.

### Additional Select Examples

Example 1 provides an apparatus, including one or more memories storing machine-readable instructions; and one or more computer processors, when executing the machine-readable instructions, are to perform operations including: extracting one or more content chunks from a document having multimodal content, the one or more content chunks including at least one of: a textual content chunk, an image content chunk, and a table content chunk; generating metadata for the table content chunk by processing text of the table content chunk; generating further metadata for the table content chunk by processing a screenshot of the table content chunk; generating an embedding vector for the table content chunk; and storing the embedding vector, the metadata, and the further metadata in a visual data management system.

Example 2 provides the apparatus of example 1, where extracting the one or more content chunks includes assigning a chunk identifier and a parent chunk identifier to a content chunk of the one or more content chunks.

Example 3 provides the apparatus of example 1 or 2, where extracting the one or more content chunks includes extracting a content chunk of the one or more content chunks from the document; and extracting a further content chunk of the one or more content chunks from the document, where the further content chunk overlaps with the content chunk by an overlap amount.

Example 4 provides the apparatus of any one of examples 1-3, where the text of the table content chunk includes a semantic representation having machine-readable text of one or more of: table cell content, header row content, header column content, and table title content.

Example 5 provides the apparatus of any one of examples 1-4, where the screenshot of the table content chunk includes a visual representation having one or more of: table layout, table cell content, header row content, header column content, and table title content.

Example 6 provides the apparatus of any one of examples 1-5, where the operations further include: generating a further embedding vector for the textual content chunk; determining yet further metadata for the textual content chunk; and storing the further embedding vector and the yet further metadata in the visual data management system.

Example 7 provides the apparatus of any one of examples 1-6, where the operations further include: generating a further embedding vector for the image content chunk; determining yet further metadata for the image content chunk; and storing the further embedding vector and the yet further metadata in the visual data management system.

Example 8 provides the apparatus of example 7, where determining yet further metadata for the image content chunk includes generating a summary describing the image content chunk.

Example 9 provides the apparatus of example 7 or 8, where determining yet further metadata for the image content chunk includes generating one or more keywords about the image content chunk.

Example 10 provides the apparatus of any one of examples 1-9, where the visual data management system includes a graph store to store metadata for the one or more content chunks; and a vector store to store embedding vectors for the one or more content chunks.

Example 11 provides an apparatus, including one or more memories storing machine-readable instructions; and one or more computer processors, when executing the machine-readable instructions, are to perform operations including: receiving a query; generating a dense vector representing of the query and a filter; inputting the dense vector and the filter into a visual data management system that stores metadata and embedding vectors, the metadata encoding hierarchical information about multimodal content of a document collection; receiving, from the visual data management system, one or more documents that match the dense vector and the filter; and generating a response to the query based on the one or more documents.

Example 12 provides the apparatus of example 11, where the visual data management system includes a graph store to store the metadata associated with one or more content chunks; and a vector store to store the embedding vectors associated with the one or more content chunks.

Example 13 provides the apparatus of example 12, where the one or more content chunks include one or more of: a textual content chunk, an image content chunk, and a table content chunk.

Example 14 provides the apparatus of example 12 or 13, where the one or more content chunks include a chunk and a further chunk that overlaps with the chunk by an overlap amount.

Example 15 provides the apparatus of any one of examples 12-14, where the metadata associated with the one or more content chunks includes a chunk identifier and a parent chunk identifier.

Example 16 provides the apparatus of any one of examples 11-15, where generating the response includes inputting a prompt and the one or more documents into a large language model.

Example 17 provides the apparatus of example 16, where the prompt includes one or more instructions to: consider document structure; consider visual elements; analyze table layout; consider data relationships; and consider technical terminology.

Example 18 provides one or more non-transitory computer readable media including instructions, that when executed by one or more processors, cause the one or more processors to perform operations including extracting one or more content chunks from a document having multimodal content, the one or more content chunks including at least one of: a textual content chunk, an image content chunk, and a table content chunk; generating metadata for the table content chunk by processing text of the table content chunk; generating further metadata for the table content chunk by processing a screenshot of the table content chunk; generating an embedding vector for the table content chunk; and storing the embedding vector, the metadata, and the further metadata in a visual data management system.

Example 19 provides the one or more non-transitory computer readable media of example 18, where extracting the one or more content chunks includes assigning a chunk identifier and a parent chunk identifier to a content chunk of the one or more content chunks.

Example 20 provides the one or more non-transitory computer readable media of example 18 or 19, where extracting the one or more content chunks includes extracting a content chunk of the one or more content chunks from the document; and extracting a further content chunk of the one or more content chunks from the document, where the further content chunk overlaps with the content chunk by an overlap amount.

Example 21 provides the one or more non-transitory computer readable media of any one of examples 18-20, where the text of the table content chunk includes a semantic representation having machine-readable text of one or more of: table cell content, header row content, header column content, and table title content.

Example 22 provides the one or more non-transitory computer readable media of any one of examples 18-21, where the screenshot of the table content chunk includes a visual representation having one or more of: table layout, table cell content, header row content, header column content, and table title content.

Example 23 provides the one or more non-transitory computer readable media of any one of examples 18-22, where the operations further include: generating a further embedding vector for the textual content chunk; determining yet further metadata for the textual content chunk; and storing the further embedding vector and the yet further metadata in the visual data management system.

Example 24 provides the one or more non-transitory computer readable media of any one of examples 18-23, where the operations further include: generating a further embedding vector for the image content chunk; determining yet further metadata for the image content chunk; and storing the further embedding vector and the yet further metadata in the visual data management system.

Example 25 provides the one or more non-transitory computer readable media of example 24, where determining yet further metadata for the image content chunk includes generating a summary describing the image content chunk.

Example 26 provides the one or more non-transitory computer readable media of example 24 or 25, where determining yet further metadata for the image content chunk includes generating one or more keywords about the image content chunk.

Example 27 provides the one or more non-transitory computer readable media of any one of examples 18-26, where the visual data management system includes a graph store to store metadata for the one or more content chunks; and a vector store to store embedding vectors for the one or more content chunks.

Example 28 provides one or more non-transitory computer readable media including instructions, that when executed by one or more processors, cause the one or more processors to perform operations including receiving a query; generating a dense vector representing of the query and a filter; inputting the dense vector and the filter into a visual data management system that stores metadata and embedding vectors, the metadata encoding hierarchical information about multimodal content of a document collection; receiving, from the visual data management system, one or more documents that match the dense vector and the filter; and generating a response to the query based on the one or more documents.

Example 29 provides the one or more non-transitory computer readable media of example 28, where the visual data management system includes a graph store to store the metadata associated with one or more content chunks; and a vector store to store the embedding vectors associated with the one or more content chunks.

Example 30 provides the one or more non-transitory computer readable media of example 29, where the one or more content chunks include one or more of: a textual content chunk, an image content chunk, and a table content chunk.

Example 31 provides the one or more non-transitory computer readable media of example 29 or 30, where the one or more content chunks include a chunk and a further chunk that overlaps with the chunk by an overlap amount.

Example 32 provides the one or more non-transitory computer readable media of any one of examples 29-31, where the metadata associated with the one or more content chunks includes a chunk identifier and a parent chunk identifier.

Example 33 provides the one or more non-transitory computer readable media of any one of examples 28-32, where generating the response includes inputting a prompt and the one or more documents into a large language model.

Example 34 provides the one or more non-transitory computer readable media of example 33, where the prompt includes one or more instructions to: consider document structure; consider visual elements; analyze table layout; consider data relationships; and consider technical terminology.

Example 35 provides a method, including extracting one or more content chunks from a document having multimodal content, the one or more content chunks including at least one of: a textual content chunk, an image content chunk, and a table content chunk; generating metadata for the table content chunk by processing text of the table content chunk; generating further metadata for the table content chunk by processing a screenshot of the table content chunk; generating an embedding vector for the table content chunk; and storing the embedding vector, the metadata, and the further metadata in a visual data management system.

Example 36 provides the method of example 35, where extracting the one or more content chunks includes assigning a chunk identifier and a parent chunk identifier to a content chunk of the one or more content chunks.

Example 37 provides the method of example 35 or 36, where extracting the one or more content chunks includes extracting a content chunk of the one or more content chunks from the document; and extracting a further content chunk of the one or more content chunks from the document, where the further content chunk overlaps with the content chunk by an overlap amount.

Example 38 provides the method of any one of examples 35-37, where the text of the table content chunk includes a semantic representation having machine-readable text of one or more of: table cell content, header row content, header column content, and table title content.

Example 39 provides the method of any one of examples 35-38, where the screenshot of the table content chunk includes a visual representation having one or more of: table layout, table cell content, header row content, header column content, and table title content.

Example 40 provides the method of any one of examples 35-39, further including generating a further embedding vector for the textual content chunk; determining yet further metadata for the textual content chunk; and storing the further embedding vector and the yet further metadata in the visual data management system.

Example 41 provides the method of any one of examples 35-40, further including generating a further embedding vector for the image content chunk; determining yet further metadata for the image content chunk; and storing the further embedding vector and the yet further metadata in the visual data management system.

Example 42 provides the method of example 41, where determining yet further metadata for the image content chunk includes generating a summary describing the image content chunk.

Example 43 provides the method of example 41 or 42, where determining yet further metadata for the image content chunk includes generating one or more keywords about the image content chunk.

Example 44 provides the method of any one of examples 35-43, where the visual data management system includes a graph store to store metadata for the one or more content chunks; and a vector store to store embedding vectors for the one or more content chunks.

Example 45 provides a method, including receiving a query; generating a dense vector representing of the query and a filter; inputting the dense vector and the filter into a visual data management system that stores metadata and embedding vectors, the metadata encoding hierarchical information about multimodal content of a document collection; receiving, from the visual data management system, one or more documents that match the dense vector and the filter; and generating a response to the query based on the one or more documents.

Example 46 provides the method of example 45, where the visual data management system includes a graph store to store the metadata associated with one or more content chunks; and a vector store to store the embedding vectors associated with the one or more content chunks.

Example 47 provides the method of example 46, where the one or more content chunks include one or more of: a textual content chunk, an image content chunk, and a table content chunk.

Example 48 provides the method of example 46 or 47, where the one or more content chunks include a chunk and a further chunk that overlaps with the chunk by an overlap amount.

Example 49 provides the method of any one of examples 46-48, where the metadata associated with the one or more content chunks includes a chunk identifier and a parent chunk identifier.

Example 50 provides the method of any one of examples 45-49, where generating the response includes inputting a prompt and the one or more documents into a large language model.

Example 51 provides the method of example 50, where the prompt includes one or more instructions to: consider document structure; consider visual elements; analyze table layout; consider data relationships; and consider technical terminology.

Example 52 provides an apparatus including means for performing a method according to any one of examples 35-51.

### Variations and Other Notes

Although the operations of the example method shown in and described with reference to FIGS. are illustrated as occurring once each and in a particular order, it will be recognized that the operations may be performed in any suitable order and repeated as desired. Additionally, one or more operations may be performed in parallel. Furthermore, the operations illustrated in FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An apparatus, comprising:
one or more memories storing machine-readable instructions; and
one or more computer processors, when executing the machine-readable instructions, are to perform operations including:
generating one or more embedding vectors by analyzing a multimodal document having one or more types of content;
generating metadata associated with the one or more embedding vectors of the multimodal document; and
storing the one or more embedding vectors, the metadata, and the multimodal document in a visual data management system.

2. The apparatus of claim 1, wherein analyzing the multimodal document comprises:
parsing the multimodal document into one or more content chunks, the one or more content chunks including at least one of: a textual content chunk, an image content chunk and a table content chunk.

3. The apparatus of claim 2, wherein generating the one or more embedding vectors comprises:
generating the one or more embedding vectors by processing the one or more content chunks.

4. The apparatus of claim 2, wherein generating the metadata comprises:
determining the metadata by processing the one or more content chunks.

5. The apparatus of claim 2, wherein generating the one or more embedding vectors comprises:
generating an embedding vector for the table content chunk by processing text of the table content chunk; and
generating an additional embedding vector for the table content chunk by processing a screenshot of the table content chunk.

6. The apparatus of claim 5, wherein the text of the table content chunk comprises a semantic representation having machine-readable text of one or more of: table cell content, header row content, header column content, and table title content.

7. The apparatus of claim 5, wherein the screenshot of the table content chunk comprises a visual representation having one or more of: table layout, table cell content, header row content, header column content, and table title content.

8. The apparatus of claim 2, wherein generating the metadata comprises:
generating one or more keywords describing content of a content chunk of the one or more content chunks.

9. The apparatus of claim 8, wherein generating the metadata comprises:
generating a vectorized representation of the one or more keywords.

10. The apparatus of claim 2, wherein generating the metadata comprises:
generating a summary describing content of a content chunk of the one or more content chunks.

11. The apparatus of claim 10, wherein generating the metadata comprises:
generating a vectorized representation of the summary.

12. The apparatus of claim 2, wherein generating the metadata comprises:
assigning a chunk identifier and a parent chunk identifier to a content chunk of the one or more content chunks.

13. The apparatus of claim 1, wherein analyzing the multimodal document comprises:
extracting a content chunk from the multimodal document; and
extracting a further content chunk from the multimodal document, wherein the further content chunk overlaps with the content chunk by an overlap amount.

14. The apparatus of claim 1, wherein the visual data management system comprises:
a graph store to store the metadata; and
a vector store to store the one or more embedding vectors.

15. One or more non-transitory computer readable media comprising instructions, that when executed by one or more processors, cause the one or more processors to perform operations comprising:
generating one or more embedding vectors by analyzing a multimodal document having one or more types of content;
generating metadata associated with the one or more embedding vectors of the multimodal document; and
storing the one or more embedding vectors, the metadata, and the multimodal document in a visual data management system.

16. The one or more non-transitory computer readable media of claim 15, wherein analyzing the multimodal document comprises:
parsing the multimodal document into one or more content chunks, the one or more content chunks including at least one of: a textual content chunk, an image content chunk and a table content chunk.

17. The one or more non-transitory computer readable media of claim 16, wherein generating the one or more embedding vectors comprises:
generating the one or more embedding vectors by processing the one or more content chunks.

18. The one or more non-transitory computer readable media of claim 16, wherein generating the metadata comprises:
determining the metadata by processing the one or more content chunks.

19. A method, comprising:
generating one or more embedding vectors by analyzing a multimodal document having one or more types of content;
generating metadata associated with the one or more embedding vectors of the multimodal document; and
storing the one or more embedding vectors, the metadata, and the multimodal document in a visual data management system.

20. The method of claim 19, wherein analyzing the multimodal document comprises:
extracting a content chunk from the multimodal document; and
extracting a further content chunk from the multimodal document, wherein the further content chunk overlaps with the content chunk by an overlap amount.
